(19) United States
(12) Patent Application Publication
(10) Pub. No.: US 2004/0248955 A1
(43) Pub. Date: Dec. 9, 2004

(54) Fungicide active substance combinaitons

(76) Inventors: Ulrike Wachendorff-Neumann, Neuwied (DE); Thomas Seitz, CropScience (DE)

Correspondence Address: Patent Department, Bayer CropScience, 100 Bayer Road, Pittsburgh, PA, 15205-9741, US

(21) Appl. No.: 10/487,188

(22) PCT Filed: Aug. 12, 2002
(86) PCT No.: PCT/EP02/09000

(30) Foreign Application Priority Data
Aug. 24, 2001 (DE) 101-41-618.0

(51) Int. Cl. A01N 43/64; A01N 47/10

(52) U.S. Cl. 514/383; 514/485

(57) ABSTRACT

The present invention relates to novel active compound combinations of a valinamide derivative of the formula

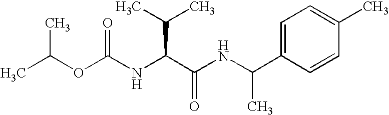

and the active compound groups (1) to (27) listed in the disclosure.

The present invention relates to novel active compound combinations which consist of a known valinamide derivative and further known active compounds, which are highly suitable for controlling phytopathogenic fungi.

It is already known that 1-methylethyl [2-methyl-1-[[[(1S)-1-(4-methylphenyl)ethyl]amino]carbonyl]propyl]carbamate have fungicidal properties (cf. EP-A-472 996). The activity of this compound is good; however, at low application rates is sometimes unsatisfactory.

Furthermore, it is already known that a large number of triazole derivatives, aniline derivatives, dicarboximides and other heterocyclic compounds can be employed for controlling fungi (cf. EP-A-0 040 345, DE-A 22 01 063, DE-A 23 24 010, Pesticide Manual, 9th. Edition (1991), pages 249 and 827, EP-A-0 382 375 and EP-A-0 515 901). Likewise, the activity of these compounds is not always satisfactory at low application rates.

Furthermore, it is known that 1-[(6-chloro-3-pyridinyl)methyl]-N-nitro-2-imidazolidinimine can be used for controlling animal pests such as insects (cf. Pesticide Manual, 9th. Edition (1991), page 491). However, fungicidal properties have hitherto not been described for this compound.

Furthermore, it is known that substituted azadioxacycloalkenes have fungicidal action (cf. EP-A-712 396).

Finally, it is known that valinamide derivatives of the formula (I) can be employed in combination with other active compounds (cf. EP-A-610 764, EP-A-944 318, WO 00/030440, WO 00/045638). The activity of these mixtures is good; however, it is sometimes unsatisfactory.

It has now been found that the novel active compound combinations comprising valinamide derivatives of the formula (I)

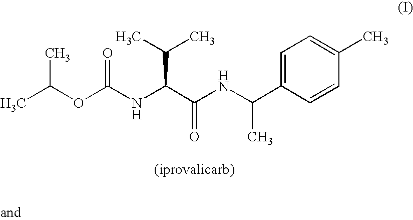

(1) a triazole derivative of the formula

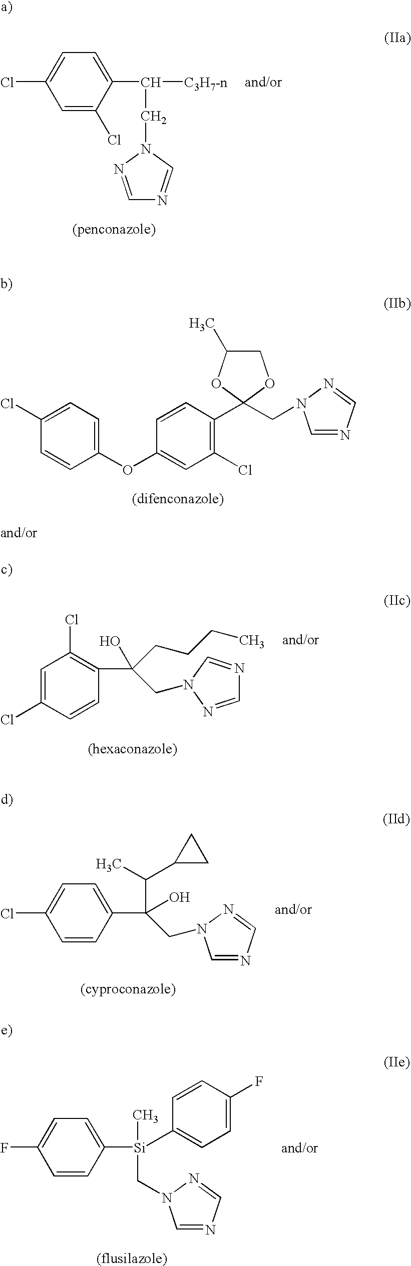

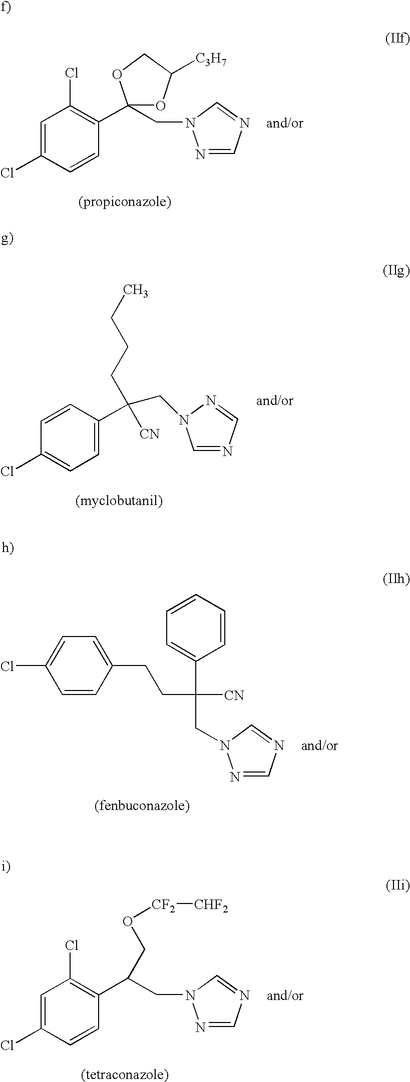

(2) the cyclopropanecarboxamide of the formula

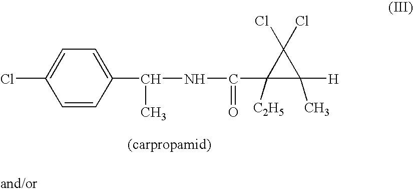

(3) the thiocarbamate of the formula

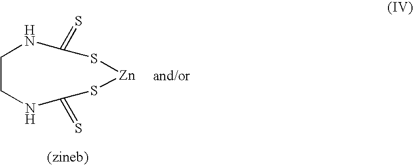

(4) the aniline derivative of the formula

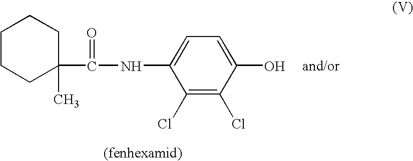

(5) the benzothiadiazole derivative of the formula

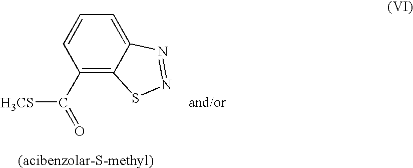

(6) the compound of the formula

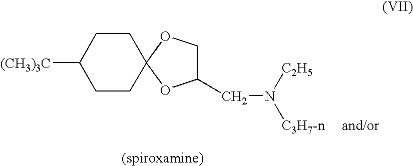

(7) the compound of the formula

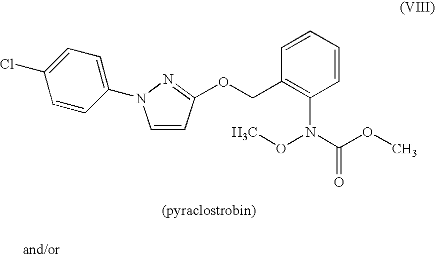

(8) a pyrimidine derivative of the formula

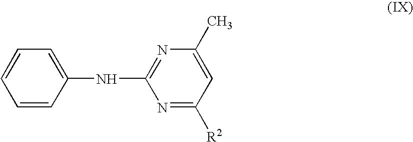

in which R² represents

methyl (pyrimethanil), (IXa)

cyclopropyl (cyprodinyl) or (IXb)

—C≡C—CH₃ (mepanipyrim), (IXc)

and/or

(9) the compound of the formula

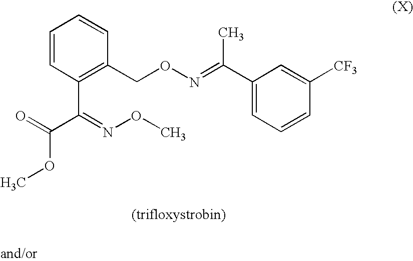

(10) the hydroxyethyltriazole derivative of the formula

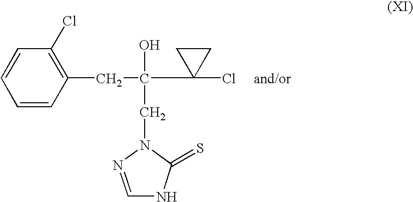

(11) a methoxyiminoacetamide of the formula

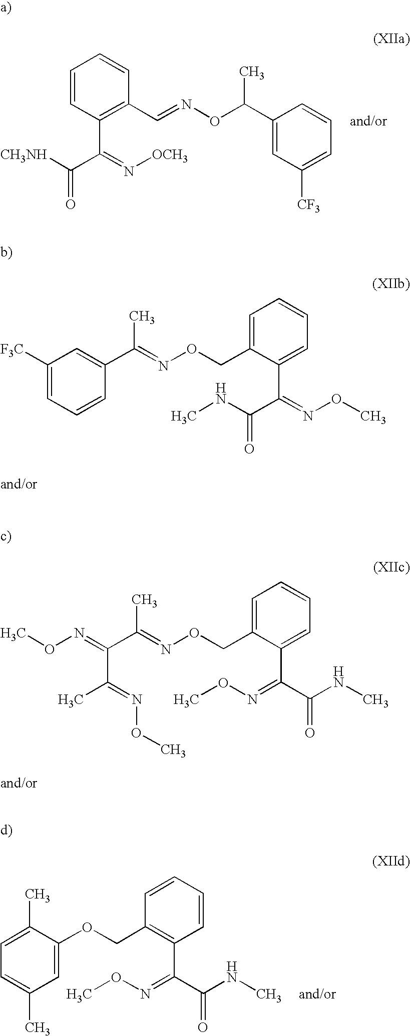

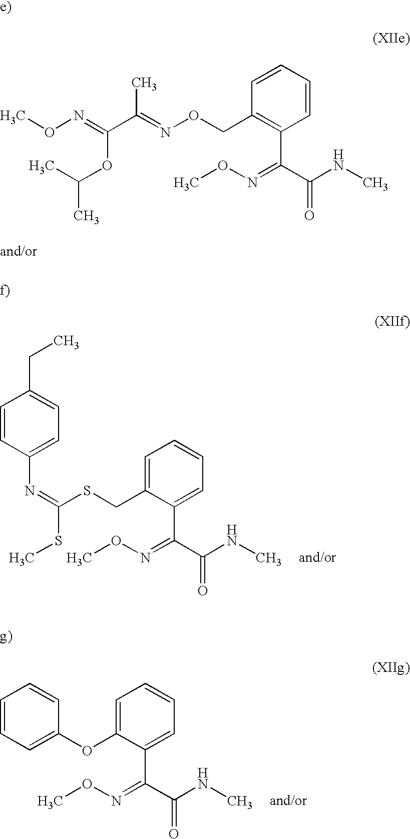

(12) the oxazolidinedione of the formula

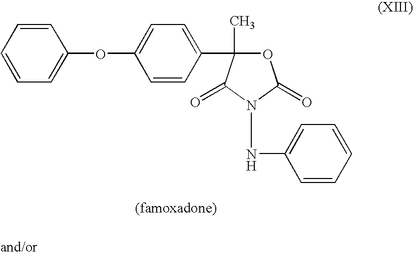

(13) the benzamide derivative of the formula

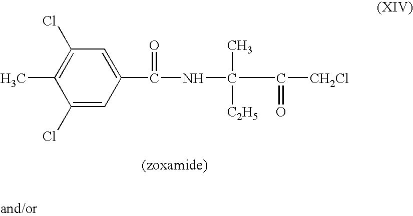

(14) a guanidine derivative of the formula

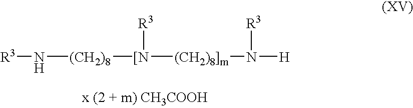

in which

m represents integers from 0 to 5 and

R³ represents hydrogen (17 to 23%) or the radical of the formula

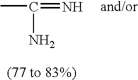

(15) the thiazolecarboxamide of the formula

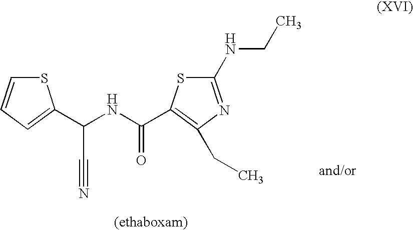

(16) the compound of the formula

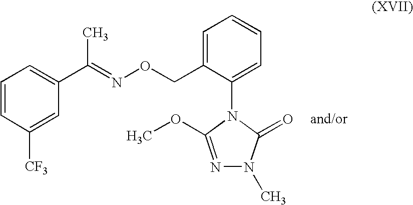

(17) the compound of the formula

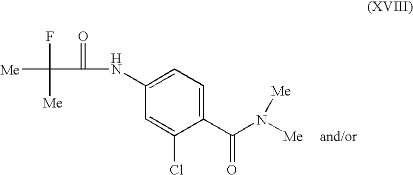

(18) the dicarboximide of the formula

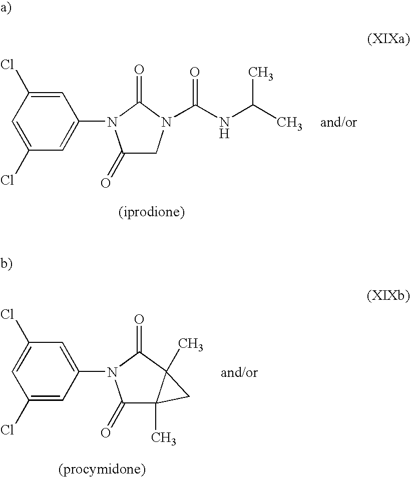

(19) the methoxyacrylate derivative of the formula

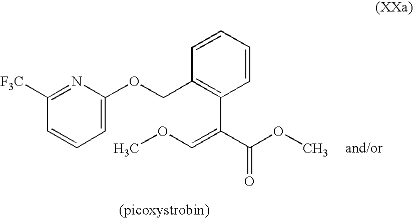

(20) the quinoline derivative of the formula

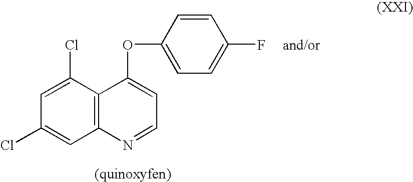

(21) the phenylamide derivative of the formula

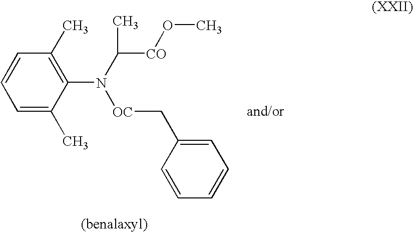

(22) the phosphorous acid of the formula

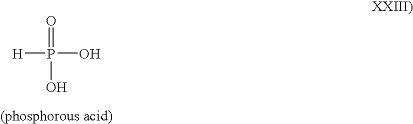

and their crop-compatible salts, such as, for example, the aluminium salts, and/or

(23) a pyrrole derivative of the formula

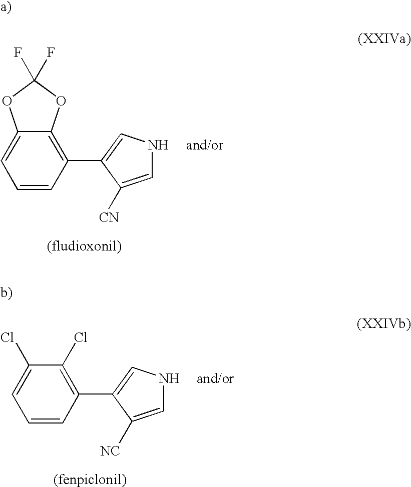

(24) the phenylcarbamate of the formula

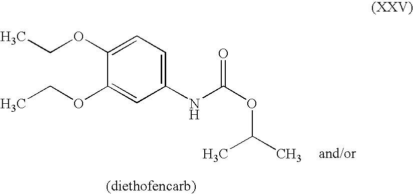

(25) copper hydroxide (XXVI) such as copper(I) and copper(II) hydroxide, in particular copper(II) hydroxide, and/or

(26) the imidazole derivative of the formula

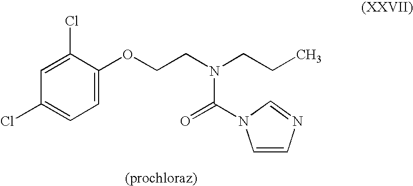

have very good fungicidal properties.

Surprisingly, the fungicidal activity of the active compound combinations according to the invention is considerably higher than the sum of the activities of the individual active compounds. Thus, an unforeseeable, true synergistic effect is present, and not just an addition of activities.

From the structural formula of the active compound of the formula (I), it can be seen that the compound has two asymmetrically substituted carbon atoms. Accordingly, the product can be present in the form of a mixture of different isomers or as a single isomer. Preference is given to compounds of the formula (I-a) in which the amino acid moiety is formed by isopropoxycarbonyl-L-valine and the phenethylamine moiety has the R(+) configuration.

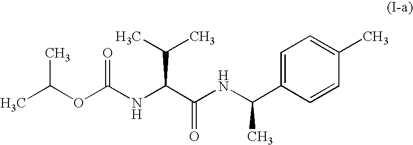

From the structural formula of the active compound of the formula (III), it can be seen that the compound has three asymmetrically substituted carbon atoms. Accordingly, the product can be present as a mixture of different isomers or else in the form of a single component. Particular preference is given to the compounds

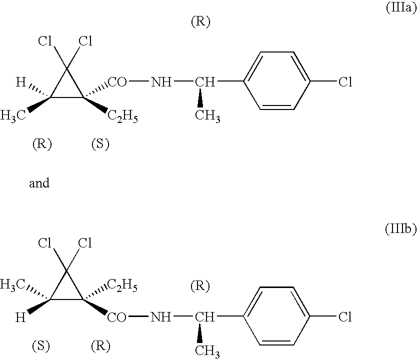

The hydroxyethyltriazole derivative of the formula (XI) can be present in the “thiono” form of the formula

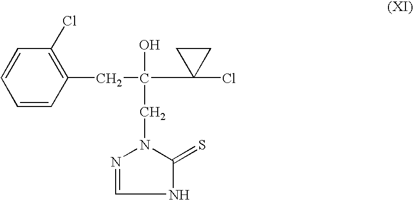

or in the tautomeric “mercapto” form of the formula

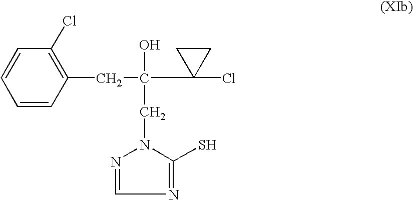

For the sake of simplicity, only the “thiono” form is given in each case.

The guanidine derivative of the formula (XV) is a substance mixture with the common name guazatine.

Preferred mixing partners for the compounds of the formula (I) are the active compounds below:

(3) zineb (IV),

(4) fenhexamid (V),

(6) spiroxamine (VII),

(7) the compound of the formula (VIII),

(8a) pyrimethanil (IXa),

(8b) cyprodinil (IXb),

(8c) mepanipyrim (IXc),

(9) trifloxystrobin (X),

(10) the compound of the formula (XI),

(11d) the compound of the formula (XIId),

(12) famoxadone (XII),

(13) zoxamide (XIV),

(14) the compounds of the formula (XV),

(15) ethaboxam (XVI),

(21) benalaxyl (XXII) and

(22) phosphorous acid (XXIII).

Particularly preferred mixing partners for the compounds of the formula (I) are the following active compounds:

(7) the compound of the formula (VIII),

(8a) pyrimethanil (IXa),

(8b) cyprodinil (IXb),

(8c) mepanipyrim (IXc),

(9) trifloxystrobin (X),

(11d) the compound of the formula (XIId),

(12) famoxadone (XIII),

(13) zoxamide (XIV),

(15) ethaboxam (XVI),

(21) benalaxyl (XXII) and

(22) phosphorous acid (XXIII).

Preferred mixing partners for the compounds of the formula (I-a) are the following active compounds:

(3) zineb (IV),

(4) fenhexamid (V),

(6) spiroxamine (VII),

(7) the compound of the formula (VIII),

(8a) pyrimethanil (IXa),

(8b) cyprodinil (IXb),

(8c) mepanipyrim (IXc),

(9) trifloxystrobin (X),

(10) the compound of the formula (XI),

(11d) the compound of the formula (XIId),

(12) famoxadone (XIII),

(13) zoxamide (XIV),

(14) the compounds of the formula (XV),

(15) ethaboxam (XVI),

(21) benalaxyl (XXII) and

(22) phosphorous acid (XXIII).

Particularly preferred mixing partners for the compounds of the formula (I-a) are the following active compounds:

(7) the compound of the formula (VIII),

(8a) pyrimethanil (IXa),

(8b) cyprodinil (IXb),

(8c) mepanipyrim (IXc),

(9) trifloxystrobin (X),

(11d) the compound of the formula (XIId),

(12) famoxadone (XIII),

(13) zoxamide (XIV),

(15) ethaboxam (XVI),

(21) benalaxyl (XXII) and

(22) phosphorous acid (XXIII).

Specifically, the active compounds are described in the following publications:

(1) compound of the formula (II)

a) Pesticide Manual, 11th. Ed. (1997), page 933

b) EP-A-112 284,

c) DE-A-3 042 303

d) DE-A-3 406 993

e) EP-A-68 813

f) DE-A-2551560

g) EP-A-145 294

h) DE-A-3 721 786

i) EP-A-234 242

(2) compound of the formula (III)

EP-A-0 341 475, Pesticide Manual, 11th. Ed. (1997), page 744

(3) compounds of the formula (IV)

Pesticide Manual, 11th. Ed. (1997), page 757

(4) compound of the formula (V)

EP-A-0 339 418

(5) compound of the formula (VI)

EP-A-313 512, Pesticide Manual, 11th. Ed. (1997), page 195

(6) compound of the formula (VII)

EP-A-281 842, Pesticide Manual, 11th. Ed. (1997), page 746

(7) compound of the formula (VIII)

WO 96/01256

(8) compounds of the formula (IX)

a) Pesticide Manual, 11th. Ed. (1997), page 1068

b) Pesticide Manual, 11th. Ed. (1997), page 319

c) Pesticide Manual, 11th. Ed. (1997), page 464

(9) compound of the formula (X)

EP-A-460 575

(10) compound of the formula (XI)

WO 96/16048

(11) compound of the formula (XII)

a) EP-A-596 254

b) EP-A-569 384

c) DE 19 539 324

d) EP-A-398 692

e) WO 97/06133

f) EP-A-811612

g) WO 96/01256

(12) compound of the formula (XIII)

EP-A-393 911, Pesticide Manual, 11th. Ed. (1997), page 500

(13) compound of the formula (XIV)

EP-A-600 629

(14) substance of the formula (XV)

Pesticide Manual, 11th. Ed. (1997), page 709

(15) compound of the formula (XVI)

EP-A-639 547

(16) compound of the formula (XVII)

WO 98/23155

(17) compound of the formula (XVIII)

WO 98/19 539

(18) compound of the formula (XIX)

a) DE-A-2 149 923, Pesticide Manual, 11th. Ed. (1997), page 724

b) DE-A-2 012 656, Pesticide Manual, 11th. Ed. (1997), page 1003

(19) compound of the formula (XX)

a) EP-A-326 330

(20) compound of the formula (XXI)

EP-A-278 595, Pesticide Manual, 11th. Ed. (1997), page 1083

(21) compound of the formula (XXII)

DE-A-2 903 612, Pesticide Manual, 11th. Ed. (1997), page 87

(22) compound of the formula (XXIII)

known and commercially available

(23) compound of the formula (XXIV)

a) EP-A-206 999, Pesticide Manual, 11th. Ed. (1997), page 566

b) Pesticide Manual, 11th. Ed. (1997), page 522

(24) compound of the formula (XXV)

EP-A-078 663, Pesticide Manual, 11th. Ed. (1997), page 386

(25) compound of the formula (XXVI)

Pesticide Manual, 11th. Ed. (1997), page 268

(26) compound of the formula (XXVII)

DE-A-2 429 523, Pesticide Manual, 11th. Ed. (1997), page 1000.

In addition to an active compound of the formula (I), the active compound combinations according to the invention comprise at least one active compound of the compounds of groups (1) to (26). Additionally, they may comprise further fungicidally active additives.

The synergistic effect is particularly pronounced when the active compounds in the active compound combinations according to the invention are present in certain weight ratios. However, the weight ratios of the active compounds in the active compound combinations can be varied within a relatively wide range.

In general,

from 0.05 to 10 parts by weight, preferably from 0.05 to 5 parts by weight, of active compound of group (1a),

from 0.05 to 10 parts by weight, preferably from 0.05 to 5 parts by weight, of active compound of group (1b),

from 0.05 to 10 parts by weight, preferably from 0.05 to 5 parts by weight, of active compound of group (1c),

from 0.05 to 10 parts by weight, preferably from 0.05 to 5 parts by weight, of active compound of group (1d),

from 0.05 to 10 parts by weight, preferably from 0.05 to 5 parts by weight, of active compound of group (1e),

from 0.05 to 10 parts by weight, preferably from 0.05 to 5 parts by weight, of active compound of group (1f),

from 0.05 to 10 parts by weight, preferably from 0.05 to 5 parts by weight, of active compound of group (1g),

from 0.05 to 10 parts by weight, preferably from 0.05 to 5 parts by weight, of active compound of group (1h),

from 0.05 to 10 parts by weight, preferably from 0.05 to 5 parts by weight, of active compound of group (1i),

from 0.05 to 10 parts by weight, preferably from 0.05 to 5 parts by weight, of active compound of group (2),

from 0.5 to 100 parts by weight, preferably from 0.5 to 50 parts by weight, of active compound of group (3),

from 0.05 to 10 parts by weight, preferably from 0.05 to 5 parts by weight, of active compound of group (4),

from 0.05 to 10 parts by weight, preferably from 0.05 to 5 parts by weight, of active compound of group (5),

from 0.05 to 10 parts by weight, preferably from 0.05 to 5 parts by weight, of active compound of group (6),

from 0.05 to 10 parts by weight, preferably from 0.05 to 5 parts by weight, of active compound of group (7),

from 0.05 to 10 parts by weight, preferably from 0.05 to 5 parts by weight, of active compound of group (8),

from 0.05 to 10 parts by weight, preferably from 0.05 to 5 parts by weight, of active compound of group (9),

from 0.05 to 10 parts by weight, preferably from 0.05 to 5 parts by weight, of active compound of group (10),

from 0.05 to 10 parts by weight, preferably from 0.05 to 5 parts by weight, of active compound of group (11a),

from 0.05 to 10 parts by weight, preferably from 0.05 to 5 parts by weight, of active compound of group (11b),

from 0.05 to 10 parts by weight, preferably from 0.05 to 5 parts by weight, of active compound of group (11c),

from 0.05 to 10 parts by weight, preferably from 0.05 to 5 parts by weight, of active compound of group (11d),

from 0.05 to 10 parts by weight, preferably from 0.05 to 5 parts by weight, of active compound of group (11e),

from 0.05 to 10 parts by weight, preferably from 0.05 to 5 parts by weight, of active compound of group (11f),

from 0.05 to 10 parts by weight, preferably from 0.05 to 5 parts by weight, of active compound of group (11g),

from 0.05 to 10 parts by weight, preferably from 0.05 to 5 parts by weight, of active compound of group (12),

from 0.05 to 10 parts by weight, preferably from 0.05 to 5 parts by weight, of active compound of group (13),

from 0.5 to 100 parts by weight, preferably from 0.5 to 50 parts by weight, of active compound of group (14),

from 0.05 to 10 parts by weight, preferably from 0.05 to 5 parts by weight, of active compound of group (15),

from 0.05 to 10 parts by weight, preferably from 0.05 to 5 parts by weight, of active compound of group (16),

from 0.05 to 10 parts by weight, preferably from 0.05 to 5 pails by weight, of active compound of group (17),

from 0.05 to 10 parts by weight, preferably from 0.05 to 5 parts by weight, of active compound of group (18a),

from 0.05 to 10 parts by weight, preferably from 0.05 to 5 parts by weight, of active compound of group (18b),

from 0.05 to 10 parts by weight, preferably from 0.05 to 5 parts by weight, of active compound of group (19),

from 0.05 to 10 parts by weight, preferably from 0.05 to 5 parts by weight, of active compound of group (20),

from 0.05 to 10 parts by weight, preferably from 0.05 to 5 parts by weight, of active compound of group (21),

from 0.5 to 100 parts by weight, preferably from 0.5 to 50 parts by weight, of active compound of group (22),

from 0.05 to 10 parts by weight, preferably from 0.05 to 5 parts by weight, of active compound of group (23a),

from 0.05 to 10 parts by weight, preferably from 0.05 to 5 parts by weight, of active compound of group (23b),

from 0.05 to 10 parts by weight, preferably from 0.05 to 5 parts by weight, of active compound of group (24),

from 0.5 to 100 parts by weight, preferably from 0.5 to 50 parts by weight, of active compound of group (25),

from 0.05 to 10 parts by weight, preferably from 0.05 to 5 parts by weight, of active compound of group (26),

are present per part by weight of active compound of the formula (I).

In general,

from 0.05 to 20 parts by weight, preferably from 0.1 to 10 parts by weight, of active compound of group (1a),

from 0.05 to 20 parts by weight, preferably from 0.1 to 10 parts by weight, of active compound of group (1b),

from 0.05 to 20 parts by weight, preferably from 0.1 to 10 parts by weight, of active compound of group (1c),

from 0.05 to 20 parts by weight, preferably from 0.1 to 10 parts by weight, of active compound of group (1d),

from 0.05 to 20 parts by weight, preferably from 0.1 to 10 parts by weight, of active compound of group (1e),

from 0.05 to 20 parts by weight, preferably from 0.1 to 10 parts by weight, of active compound of group (1f),

from 0.05 to 20 parts by weight, preferably from 0.1 to 10 parts by weight, of active compound of group (1g),

from 0.05 to 20 parts by weight, preferably from 0.1 to 10 parts by weight, of active compound of group (1h),

from 0.05 to 20 parts by weight, preferably from 0.1 to 10 parts by weight, of active compound of group (1i),

from 0.05 to 20 parts by weight, preferably from 0.1 to 10 parts by weight, of active compound of group (2),

from 0.5 to 150 parts by weight, preferably from 1 to 100 parts by weight, of active compound of group (3),

from 0.05 to 20 parts by weight, preferably from 0.1 to 10 parts by weight, of active compound of group (4),

from 0.05 to 20 parts by weight, preferably from 0.1 to 10 parts by weight, of active compound of group (5),

from 0.05 to 20 parts by weight, preferably from 0.1 to 10 parts by weight, of active compound of group (6),

from 0.05 to 20 parts by weight, preferably from 0.1 to 10 parts by weight, of active compound of group (7),

from 0.05 to 20 parts by weight, preferably from 0.1 to 10 parts by weight, of active compound of group (8),

from 0.05 to 20 parts by weight, preferably from 0.1 to 10 parts by weight, of active compound of group (9),

from 0.05 to 20 parts by weight, preferably from 0.1 to 10 parts by weight, of active compound of group (10),

from 0.05 to 20 parts by weight, preferably from 0.1 to 10 parts by weight, of active compound of group (11a),

from 0.05 to 20 parts by weight, preferably from 0.1 to 10 parts by weight, of active compound of group (11b),

from 0.05 to 20 parts by weight, preferably from 0.1 to 10 parts by weight, of active compound of group (11c),

from 0.05 to 20 parts by weight, preferably from 0.1 to 10 parts by weight, of active compound of group (11d),

from 0.05 to 20 parts by weight, preferably from 0.1 to 10 parts by weight, of active compound of group (11e),

from 0.05 to 20 parts by weight, preferably from 0.1 to 10 parts by weight, of active compound of group (11f),

from 0.05 to 20 parts by weight, preferably from 0.1 to 10 parts by weight, of active compound of group (11g),

from 0.05 to 20 parts by weight, preferably from 0.1 to 10 parts by weight, of active compound of group (12),

from 0.05 to 20 parts by weight, preferably from 0.1 to 10 parts by weight, of active compound of group (13),

from 0.5 to 150 parts by weight, preferably from 1 to 100 parts by weight, of active compound of group (14),

from 0.05 to 20 parts by weight, preferably from 0.1 to 10 parts by weight, of active compound of group (15),

from 0.05 to 20 parts by weight, preferably from 0.1 to 10 parts by weight, of active compound of group (16),

from 0.05 to 20 parts by weight, preferably from 0.1 to 10 parts by weight, of active compound of group (17),

from 0.05 to 20 parts by weight, preferably from 0.1 to 10 parts by weight, of active compound of group (18a),

from 0.05 to 20 parts by weight, preferably from 0.1 to 10 parts by weight, of active compound of group (18b),

from 0.05 to 20 parts by weight, preferably from 0.1 to 10 parts by weight, of active compound of group (19),

from 0.05 to 20 parts by weight, preferably from 0.1 to 10 parts by weight, of active compound of group (20),

from 0.05 to 20 parts by weight, preferably from 0.1 to 10 parts by weight, of active compound of group (21),

from 0.5 to 150 parts by weight, preferably from 1 to 100 parts by weight, of active compound of group (22),

from 0.05 to 20 parts by weight, preferably from 0.1 to 10 parts by weight, of active compound of group (23a),

from 0.05 to 20 parts by weight, preferably from 0.1 to 10 parts by weight, of active compound of group (23b),

from 0.05 to 20 parts by weight, preferably from 0.1 to 10 parts by weight, of active compound of group (24),

from 0.5 to 150 parts by weight, preferably from 1 to 100 parts by weight, of active compound of group (25),

from 0.05 to 20 parts by weight, preferably from 0.1 to 10 parts by weight, of active compound of group (26),

are present per part by weight of active compound of the formula (I-a).

The active compound combinations according to the invention have very good fungicidal properties and can be employed for controlling phytopathogenic fungi, such as Plasmodiophoromycetes, Oomycetes, Chytridiomycetes, Zygomycetes, Ascomycetes, Basidiomycetes, Deuteromycetes, etc.

The active compound combinations according to the invention are particularly suitable for controlling Phytophthora infestans and Plasmopara viticola.

The fact that the active compound combinations are well tolerated by plants at the concentrations required for controlling plant diseases permits the treatment of above-ground parts of plants, of propagation stock and seeds, and of the soil. The active compound combinations according to the invention can be used for foliar application or else as seed dressing.

The active compound combinations according to the invention may also be employed to increase the yield of crops. Moreover, they have reduced toxicity and are tolerated well by plants.

All plants and plant parts can be treated in accordance with the invention. Plants are to be understood as meaning in the present context all plants and plant populations such as desired and undesired wild plants or crop plants (inclusive of naturally occurring crop plants). Crop plants can be plants which can be obtained by conventional plant breeding and optimization methods or by biotechnological and recombinant methods or by combinations of these methods, inclusive of the transgenic plants and inclusive of the plant varieties protectable or not protectable by plant breeders' rights. Plant parts are to be understood as all above-ground and below-ground parts and organs of the plants, such as shoot, leaf, flower and root, examples which may be mentioned being leaves, needles, stalks, stems, flowers, fruit bodies, fruits, seeds, roots, tubers and rhizomes. The plant parts also include harvested material, and vegetative and generative propagation material, for example cuttings, tubers, rhizomes, offsets and seeds.

As already mentioned above, it is possible to treat all plants and their parts according to the invention. In a preferred embodiment, wild plant species and plant varieties, or those obtained by conventional biological breeding, such as crossing or protoplast fusion, and parts thereof, are treated. In a further preferred embodiment, transgenic plants and plant varieties obtained by genetical engineering, if appropriate in combination with conventional methods (Genetically Modified Organisms), and parts thereof are treated. The term “parts” or “parts of plants” or “plant parts” has been explained above.

Particularly preferably, plants of the plant varieties which are in each case commercially available or in use are treated according to the invention. Plant varieties are understood as meaning plants having novel properties (traits) that may be obtained by conventional breeding, by mutagenesis or by recombinant DNA techniques. These may be varieties, bio- or genotypes.

Depending on the plant species or plant varieties, their location and growth conditions (soils, climate, vegetation period, diet), the treatment according to the invention may also result in superadditive (“synergistic”) effects. Thus, for example, reduced application rates and/or a widening of the activity spectrum and/or an increase in the activity of the substances and compositions to be used according to the invention, better plant growth, increased tolerance to high or low temperatures, increased tolerance to drought or to water or soil salt content, increased flowering performance, easier harvesting, accelerated maturation, higher harvest yields, better quality and/or a higher nutritional value of the harvested products, better storage stability and/or processability of the harvested products are possible which exceed the effects which were actually to be expected.

The transgenic plants or plant varieties (i.e. those obtained by genetical engineering) which are preferred and are to be treated according to the invention include all plants which, in the genetic modification, received genetic material which imparted particularly advantageous useful properties (“traits”) to these plants. Examples of such properties are better plant growth, increased tolerance to high or low temperatures, increased tolerance to drought or to water or soil salt content, increased flowering performance, easier harvesting, accelerated maturation, higher harvest yields, better quality and/or a higher nutritional value of the harvested products, better storage stability and/or processability of the harvested products. Further and particularly emphasized examples of such properties are a better defence of the plants against animal and microbial pests, such as against insects, mites, phytopathogenic fungi, bacteria and/or viruses, and also increased tolerance of the plants to certain herbicidally active compounds. Examples of transgenic plants which may be mentioned are the important crop plants, such as cereals (wheat, rice), maize, soya beans, potatoes, cotton, oilseed rape and also fruit plants (with the fruits apples, pears, citrus fruits and grapevines), and particular emphasis is given to maize, soya beans, potatoes, cotton and oilseed rape. Traits that are emphasized are in particular increased defence of the plants against insects by toxins formed in the plants, in particular those formed by the genetic material from Bacillus thuringiensis (for example by the genes CryLA(a), CryIA(b), CryIA(c), CryIIA, CryIIIA, CryIIIB2, Cry9c Cry2Ab, Cry3Bb and CryIF and also combinations thereof) (hereinbelow referred to as “Bt plants”). Traits that are also particularly emphasized are the increased defence of the plants against fungi, bacteria and viruses by Systemic Acquired Resistance (SAR), systemine, phytoalexines, elicitors and resistance genes and correspondingly expressed proteins and toxins. Traits that are furthermore particularly emphasized are the increased tolerance of the plants to certain herbicidally active compounds, for example imidazolinones, sulphonylureas, glyphosate or phosphinotricin (for example the “PAT” gene). The genes which impart the desired traits in question can also be present in combinations with one another in the transgenic plants. Examples of “Bt plants” which may be mentioned are maize varieties, cotton varieties, soya bean varieties and potato varieties which are sold under the trade names YIELD GARD® (for example maize, cotton, soya beans), KnockOut® (for example maize), StarLink® (for example maize), Bollgard® (cotton), Nucotn® (cotton) and NewLeaf® (potato). Examples of herbicide-tolerant plants which may be mentioned are maize varieties, cotton varieties and soya bean varieties which are sold under the trade names Roundup Ready® (tolerance to glyphosate, for example maize, cotton, soya bean), Liberty Link® (tolerance to phosphinotricin, for example oilseed rape), IMI® (tolerance to imidazolinones) and STS® (tolerance to sulphonylureas, for example maize). Herbicide-resistant plants (plants bred in a conventional manner for herbicide tolerance) which may be mentioned include the varieties sold under the name Clearfield® (for example maize). Of course, these statements also apply to plant varieties having these or still to be developed genetic traits, which plants will be developed and/or marketed in the future.

The plants listed can be treated according to the invention in a particularly advantageous manner with the active compound mixtures according to the invention. The preferred ranges stated above for the active compounds or mixtures also apply to the treatment of these plants. Particular emphasis is given to the treatment of plants with the compounds or mixtures specifically mentioned in the present text.

The treatment of the plants and parts of plants according to the invention with the active compounds is carried out directly or by action on their environment, habitat or storage area according to customary treatment methods, for example by dipping, spraying, evaporating, atomizing, broadcasting, brushing-on and, in the case of propagation material, in particular in the case of seeds, furthermnore by one- or multi-layer coating.

The active compound combinations according to the invention can be converted to the customary formulations, such as solutions, emulsions, suspensions, powders, foams, pastes, granules, aerosols and microencapsulations in polymeric substances and in coating compositions for seeds, and ULV formulations.

These formulations are produced in a known manner, for example by mixing the active compounds or active compound combinations with extenders, that is liquid solvents, liquefied gases under pressure, and/or solid carriers, optionally with the use of surfactants, that is emulsifiers and/or dispersants, and/or foam formers. If the extender used is water, it is also possible to use, for example, organic solvents as auxiliary solvents. Essentially, suitable liquid solvents include: aromatics such as xylene, toluene or alkylnaphthalenes, chlorinated aromatics or chlorinated aliphatic hydrocarbons such as chlorobenzenes, chloroethylenes or methylene chloride, aliphatic hydrocarbons such as cyclohexane or paraffins, for example petroleum fractions, alcohols such as butanol or glycol and their ethers and esters, ketones such as acetone, methyl ethyl ketone, methyl isobutyl ketone or cyclohexanone, strongly polar solvents such as dimethylformamide and dimethyl sulphoxide, or else water. Liquefied gaseous extenders or carriers are to be understood as meaning liquids which are gaseous at ambient temperature and under atmospheric pressure, for example aerosol propellants such as butane, propane, nitrogen and carbon dioxide. Suitable solid carriers are: for example ground natural minerals such as kaolins, clays, talc, chalk, quartz, attapulgite, montmorillonite or diatomaceous earth, and ground synthetic minerals such as finely divided silica, alumina and silicates. Suitable solid carriers for granules are: for example crushed and fractionated natural rocks such as calcite, marble, pumice, sepiolite and dolomite, or else synthetic granules of inorganic and organic meals, and granules of organic material such as sawdust, coconut shells, maize cobs and tobacco stalks. Suitable emulsifiers and/or foam formers are: for example nonionic and anionic emulsifiers, such as polyoxyethylene fatty acid esters, polyoxyethylene fatty alcohol ethers, for example alkylaryl polyglycol ethers, alkylsulphonates, alkyl sulphates, arylsulphonates, or else protein hydrolysates. Suitable dispersants are: for example lignin-sulphite waste liquors and methylcellulose.

Tackifiers such as carboxymethylcellulose and natural and synthetic polymers in the form of powders, granules or latices, such as gum arabic, polyvinyl alcohol and polyvinyl acetate, or else natural phospholipids such as cephalins and lecithins and synthetic phospholipids can be used in the formulations. Other additives can be mineral and vegetable oils.

It is possible to use colorants such as inorganic pigments, for example iron oxide, titanium oxide and Prussian Blue, and organic dyestuffs such as alizarin dyestuffs, azo dyestuffs and metal phthalocyanine dyestuffs, and trace nutrients such as salts of iron, manganese, boron, copper, cobalt, molybdenum and zinc.

The formulations generally comprise between 0.1 and 95% by weight of active compounds, preferably between 0.5 and 90%.

The active compound combinations according to the invention, as such or in their formulations, can also be applied in a mixture with known fungicides, bactericides, acaricides, nematicides or insecticides, to broaden the activity spectrum or to prevent the development of resistance, for example. In many cases, synergistic effects are obtained, i.e. the activity of the mixture is greater than the activity of the individual components.

A mixture with other known active compounds such as herbicides or with fertilizers and growth regulators is also possible.

The active compound combinations can be used as such, in the form of their formulations or as the use forms prepared therefrom, such as ready-to-use solutions, emulsifiable concentrates, emulsions, suspensions, wettable powders, soluble powders and granules. They are used in the customary manner, for example by watering, spraying, atomizing, scattering, spreading, and as a powder for dry seed treatment, a solution for seed treatment, a water-soluble powder for slurry treatment, or by encrusting.

When using the active compound combinations according to the invention, the application rates can be varied within a relatively wide range, depending on the kind of application. In the treatment of parts of plants, the application rates of the active compound combination are generally between 0.1 and 10,000 g/ha, preferably between 10 and 1000 g/ha. In the treatment of seeds, the application rates of the active compound combination are generally between 0.001 and 50 g per kilogram of seed, preferably between 0.01 and 10 g per kilogram of seed. In the treatment of the soil, the application rates of the active compound combination are generally between 0.1 and 10,000 g/ha, preferably between 1 and 5000 g/ha.

The good fungicidal activity of the active compound combinations according to the invention is evident from the examples below. While the individual active compounds exhibit weaknesses with regard to the fungicidal activity, the combinations have an activity which exceeds the sum of individual activities.

A synergistic effect of fungicides is always present when the fungicidal activity of the active compound combinations exceeds the total of the activities of the active compounds when applied individually.

The expected activity for a given combination of two active compounds can be calculated as follows (cf. Colby, S. R., “Calculating Synergistic and Antagonistic Responses of Herbicide Combinations”, Weeds 15, (1967), 20-22):

If

X is the efficacy when applying active compound A at an application rate of m g/ha,

Y is the efficacy when applying active compound B at an application rate of n g/ha and

E is the efficacy when applying the active compounds A and B at an application rate of m and n g/ha,

then

$$E = X + Y - \frac{X \cdot Y}{100}$$

The efficacy is calculated in %. 0% is an efficacy which corresponds to that of the control, whereas an efficacy of 100% means that no infection is observed.

If the actual fungicidal activity exceeds the calculated value, then the activity of the combination is superadditive, i.e. a synergistic effect exists. In this case, the efficacy which was actually observed must be greater than the value for the expected efficacy (E) calculated from the abovementioned formula.

The examples that follow illustrate the invention. However, the invention is not limited to the examples.

What is claimed is:

1-11 (canceled)

12: An active compound combination comprising a compound of the formula (I) 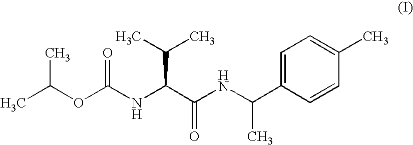
and
(1) a triazole derivative of the formula 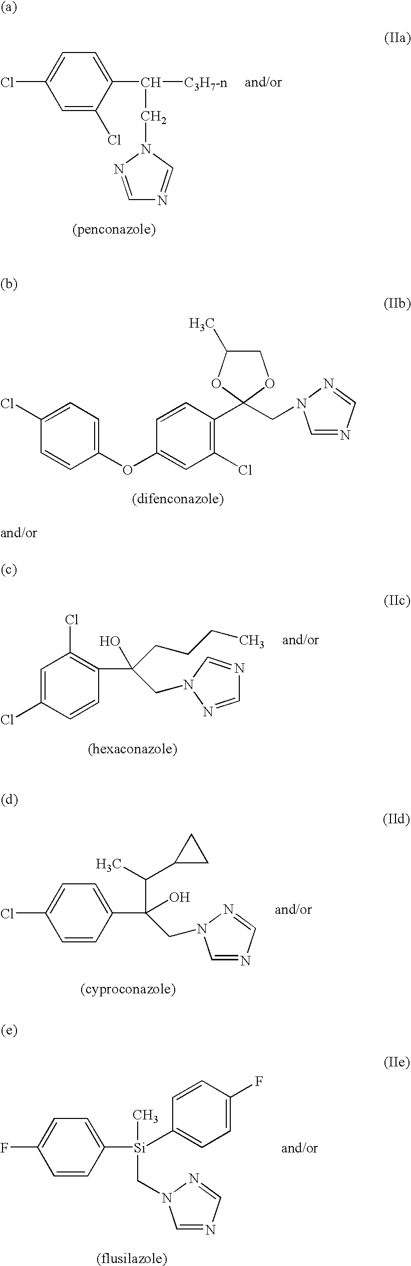 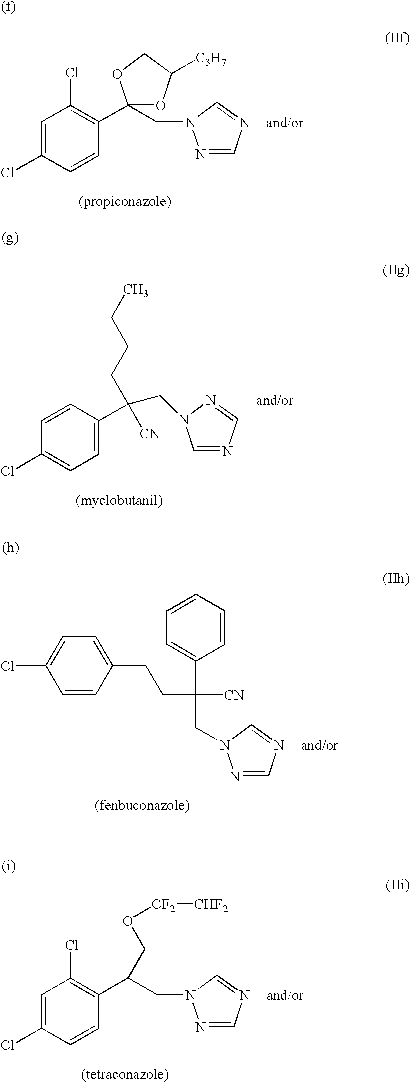
(2) a cyclopropanecarboxamide of the formula 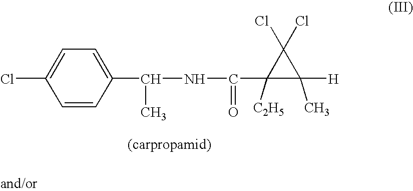
(3) a thiocarbamate of the formula 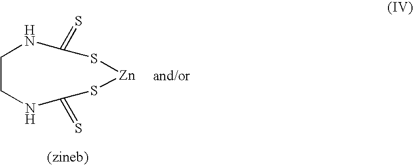
(4) an aniline derivative of the formula 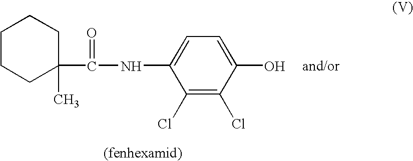
(5) a benzothiadiazole derivative of the formula 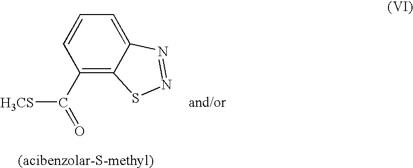
(6) a compound of the formula 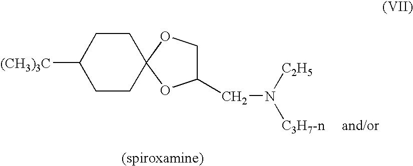
(7) a compound of the formula 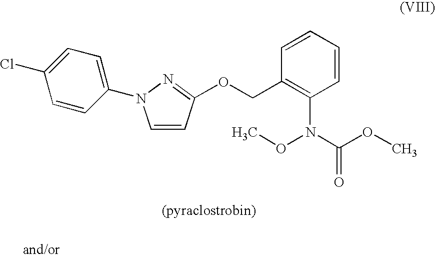
(8) a pyrimidine derivative of the formula 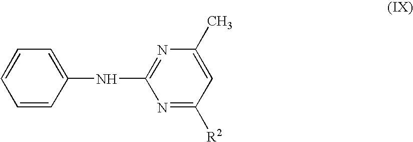
in which R² represents
methyl (pyrimethanil), (IXa)
cyclopropyl (cyprodinyl), or (IXb)
—C≡C—CH₃ (mepanipyrim) (IXc)
and/or
(9) a compound of the formula 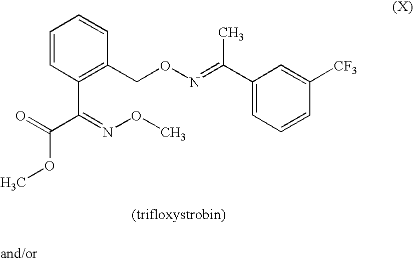
(10) a hydroxyethyltriazole derivative of the formula 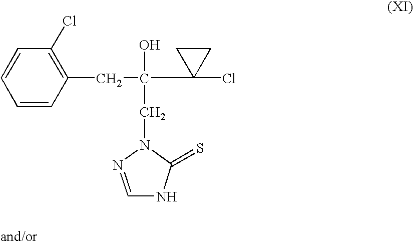
(11) a methoxyiminoacetamide of the formula 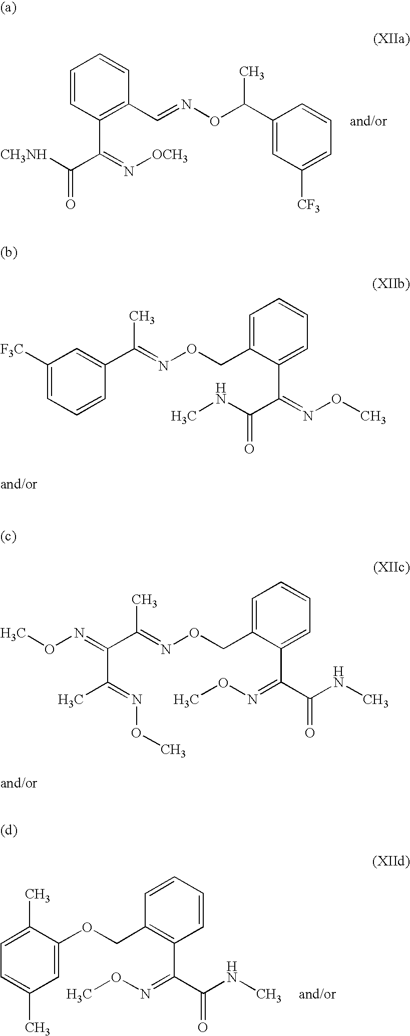 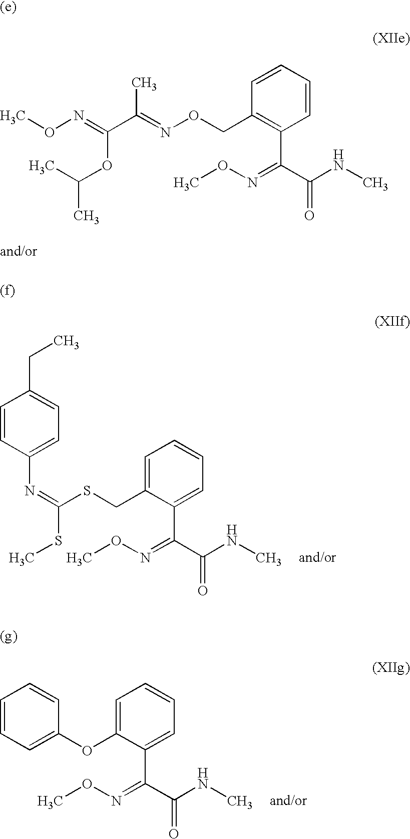
(12) an oxazolidinedione of the formula 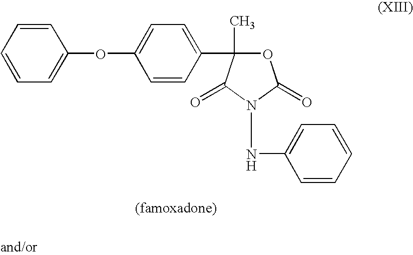
(13) a benzamide derivative of the formula 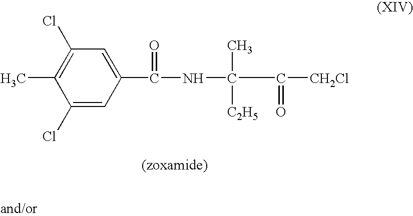
(14) a guanidine derivative of the formula 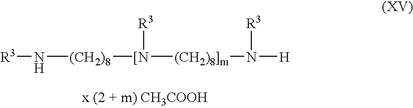
in which
m represents integers from 0 to 5, and
R³ represents hydrogen (17 to 23%) or the radical of the formula 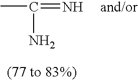
(15) a thiazolecarboxamide of the formula 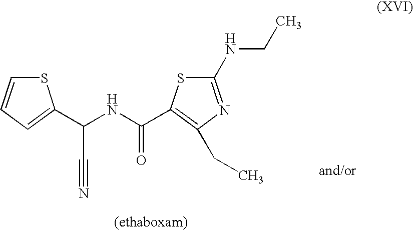
(16) a compound of the formula 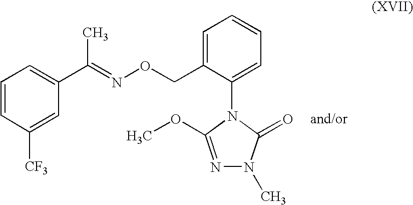
(17) a compound of the formula 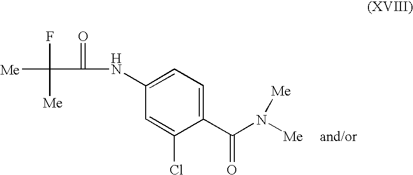
(18) a dicarboximide of the formula 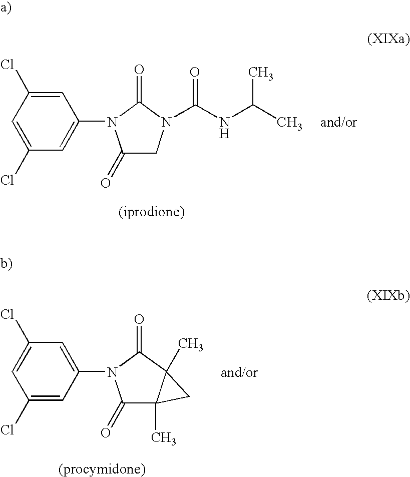
(19) a methoxyacrylate derivative of the formula 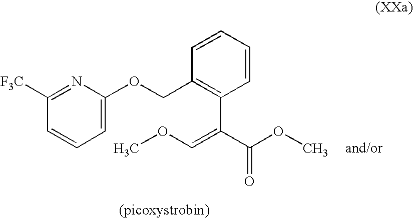
(20) a quinoline derivative of the formula 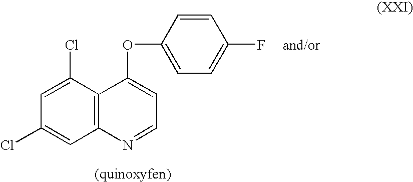
(21) a phenylamide derivative of the formula 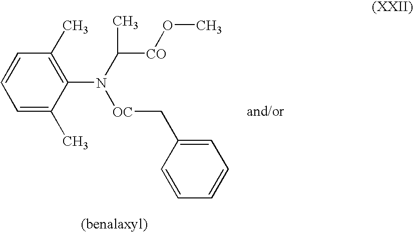
(22) phosphorous acid of the formula 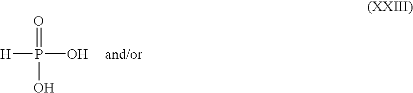
(23) a pyrrole derivative of the formula 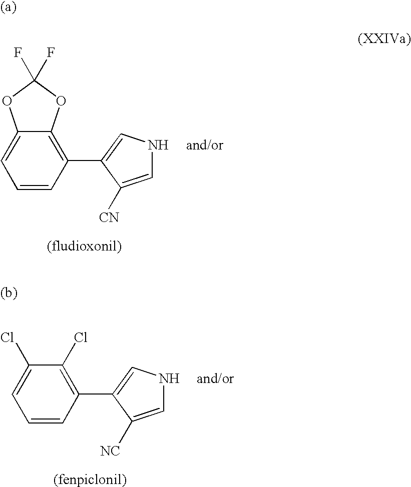
(24) a phenylcarbamate of the formula 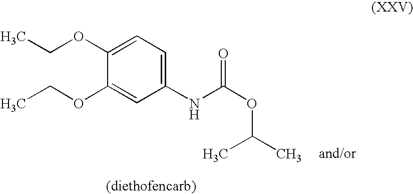
(25) copper hydroxide (XXVI)
and/or
(26) an imidazole derivative of the formula

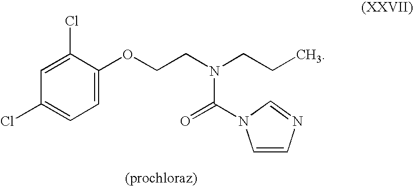

13: An active compound combination according to claim 12 comprising one or more compounds of the formula (I) and
(3) zineb (IV) and/or
(4) fenhexamid (V) and/or
(6) spiroxamine (VII) and/or
(7) the compound of formula (VIII) and/or
(8a) pyrimethanil (IXa) and/or
(8b) cyprodinil (IXb) and/or
(8c) mepanipyrim (IXc) and/or
(9) trifloxystrobin (X) and/or
(10) the compound of formula (XI) and/or
(11d) the compound of formula (XIId) and/or
(12) famoxadone (XIII) and/or
(13) zoxamide (XIV) and/or
(14) the compounds of formula (XV) and/or
(15) ethaboxam (XVI) and/or
(21) benalaxyl (XXII) and/or
(22) phosphorous acid (XXIII).

14: An active compound combination according to claim 12 comprising one or more compounds of the formula (I) and
(7) the compound of formula (VIII) and/or
(8a) pyrimethanil (IXa) and/or
(8b) cyprodinil (IXb) and/or
(8c) mepanipyrim (IXc) and/or
(9) trifloxystrobin (X) and/or
(11d) the compound of formula (XIId) and/or
(12) famoxadone (XIII) and/or
(13) zoxamide (XIV) and/or
(15) ethaboxam (XVI) and/or
(21) benalaxyl (XXII) and/or
(22) phosphorous acid (XXIII).

15: An active compound combination according to claim 12 wherein the weight ratio of the compound of the formula (I) to
(i) the compound of group (1a) is from 1:0.05 to 1:10,
(ii) the compound of group (1b) is from 1:0.05 to 1:10,
(iii) the compound of group (1c) is from 1:0.05 to 1:10,
(iv) the compound of group (1d) is from 1:0.05 to 1:10,
(v) the compound of group (1e) is from 1:0.05 to 1:10,
(vi) the compound of group (1f) is from 1:0.05 to 1:10,
(vii) the compound of group (1g) is from 1:0.05 to 1:10,
(viii) the compound of group (1h) is from 1:0.05 to 1:10,
(ix) the compound of group (1i) is from 1:0.05 to 1:10,
(x) the compound of group (2) is from 1:0.05 to 1:10,
(xi) the compound of group (3) is from 1:0.5 to 1:100,
(xii) the compound of group (4) is from 1:0.05 to 1:10,
(xiii) the compound of group (5) is from 1:0.05 to 1:10,
(xiv) the compound of group (6) is from 1:0.05 to 1:10,
(xv) the compound of group (7) is from 1:0.05 to 1:10,
(xvi) the compound of group (8) is from 1:0.05 to 1:10,
(xvii) the compound of group (9) is from 1:0.05 to 1:10,
(xviii) the compound of group (10) is from 1:0.05 to 1:10,
(xix) the compound of group (11a) is from 1:0.05 to 1:10,
(xx) the compound of group (11b) is from 1:0.05 to 1:10,
(xxi) the compound of group (11c) is from 1:0.05 to 1:10,
(xxii) the compound of group (11d) is from 1:0.05 to 1:10,
(xxiii) the compound of group (11e) is from 1:0.05 to 1:10,
(xxiv) the compound of group (11f) is from 1:0.05 to 1:10,
(xxv) the compound of group (12) is from 1:0.05 to 1:20,
(xxvi) the compound of group (12) is from 1:0.05 to 1:10,
(xxvii) the compound of group (13) is from 1:0.05 to 1:100,
(xxviii) the compound of group (14) is from 1:0.5 to 1:100,
(xxix) the compound of group (15) is from 1:0.05 to 1:10,
(xxx) the compound of group (16) is from 1:0.05 to 1:10,
(xxxi) the compound of group (17) is from 1:0.05 to 1:10,
(xxxii) the compound of group (18a) is from 1:0.05 to 1:10,
(xxxiii) the compound of group (18b) is from 1:0.05 to 1:10,
(xxxiv) the compound of group (19) is from 1:0.05 to 1:10,
(xxxv) the compound of group (20) is from 1:0.05 to 1:10,
(xxxvi) the compound of group (21) is from 1:0.05 to 1:10,
(xxxvii) the compound of group (22) is from 1:0.5 to 1:100,
(xxxviii) the compound of group (23a) is from 1:0.05 to 1:10,
(xxxix) the compound of group (23b) is from 1:0.05 to 1:10,
(xl) the compound of group (24) is from 1:0.05 to 1:10,
(xli) the compound of group (25) is from 1:0.5 to 1:100,
(xlii) the compound of group (26) is from 1:0.05 to 1:10.

16: An active compound combination comprising the compound of formula (l-a) 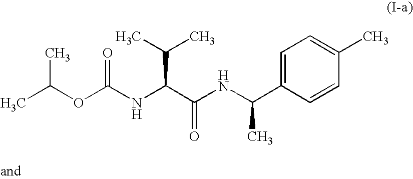
(1) a triazole derivative of the formula 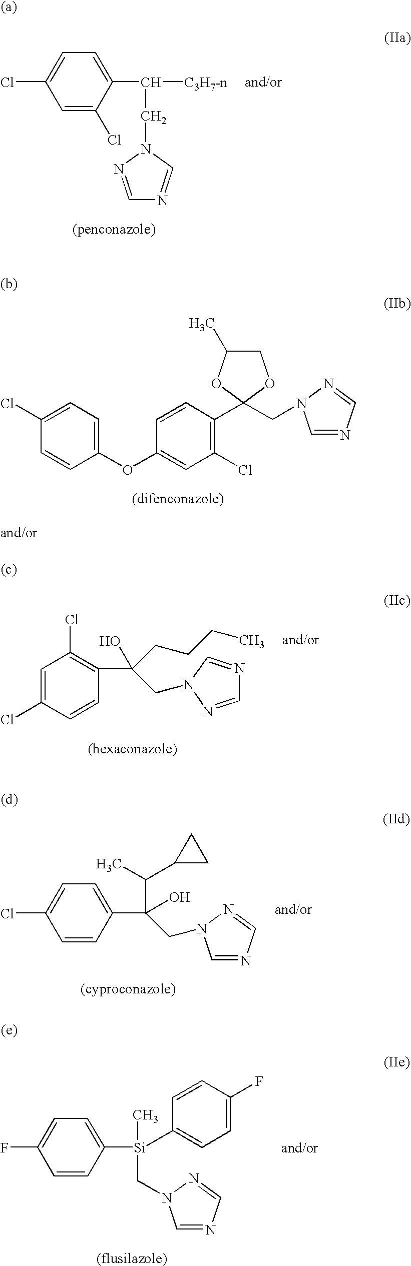 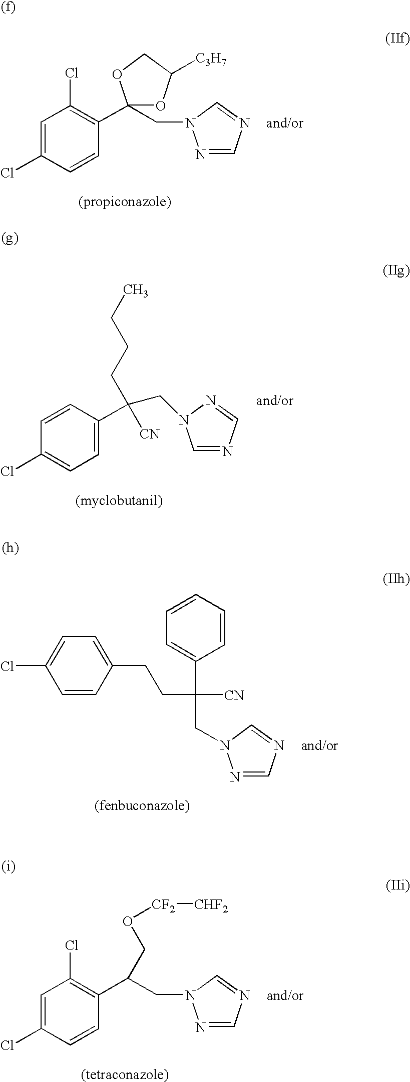
(2) a cyclopropanecarboxamide of the formula 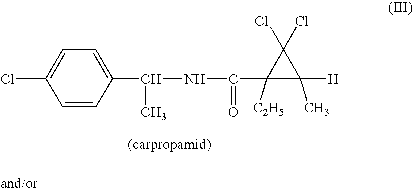
(3) a thiocarbamate of the formula 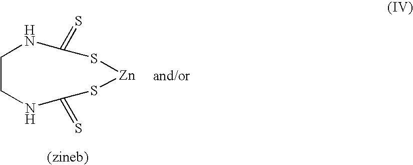
(4) an aniline derivative of the formula 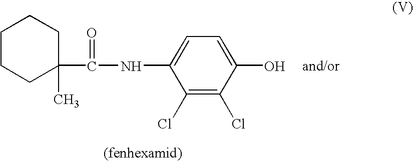
(5) a benzothiadiazole derivative of the formula 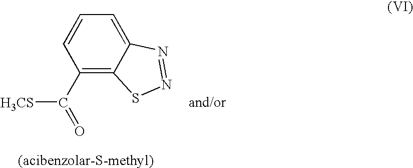
(6) a compound of the formula 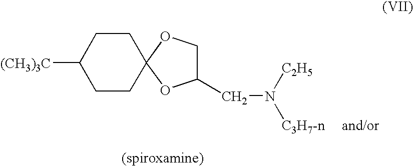
(7) a compound of the formula 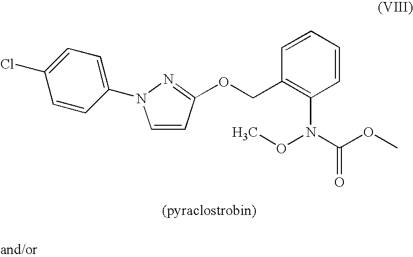
(8) a pyrimidine derivative of the formula 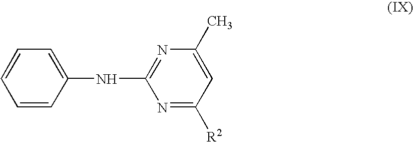
in which R² represents
methyl (pyrimethanil), (IXa)
cyclopropyl (cyprodinyl), or (IXb)
—C≡C—CH₃ (mepanipyrim) (IXc)
and/or
(9) a compound of the formula 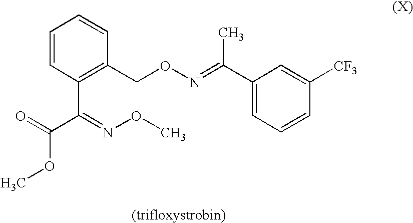
and/or
(10) a hydroxyethyltriazole derivative of the formula 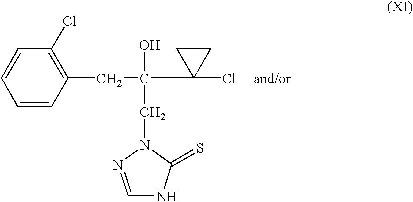
(11) a methoxyiminoacetamide of the formula 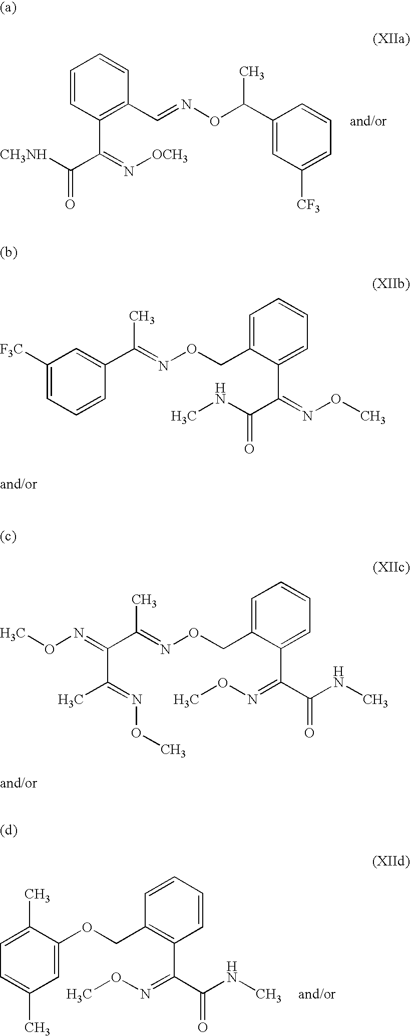 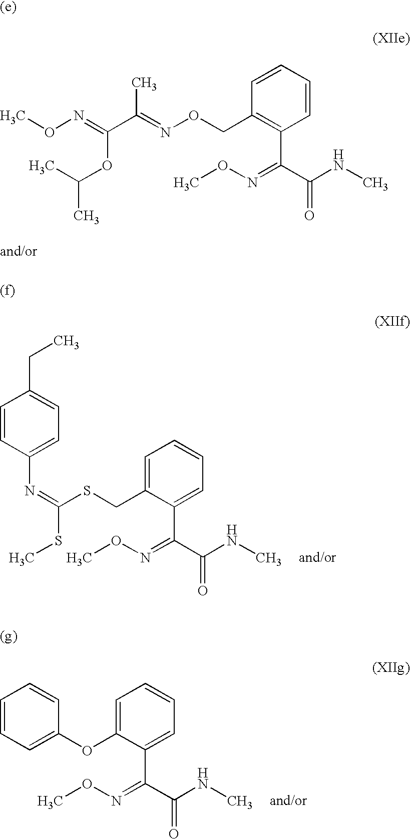
(12) an oxazolidinedione of the formula 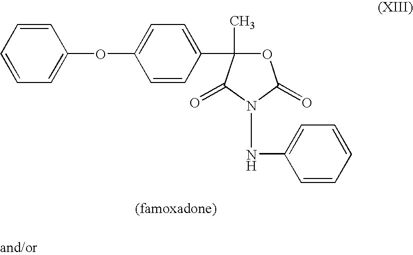
(13) a benzamide derivative of the formula 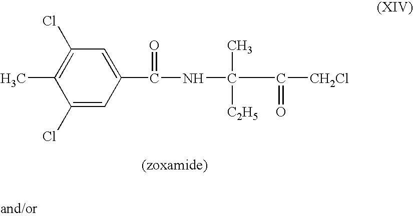
(14) a guanidine derivative of the formula 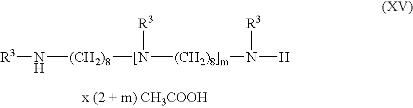
in which
m represents integers from 0 to 5, and
R³ represents hydrogen (17 to 23%) or the radical of the formula 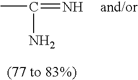
(15) a thiazolecarboxamide of the formula 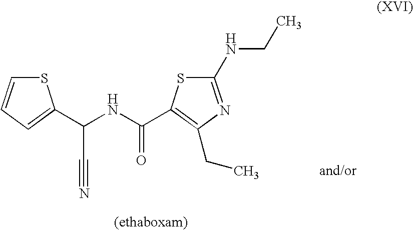
(16) a compound of the formula 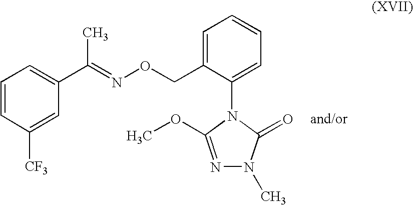
(17) a compound of the formula 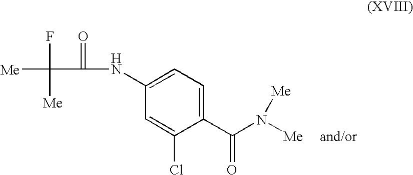
(18) a dicarboximide of the formula 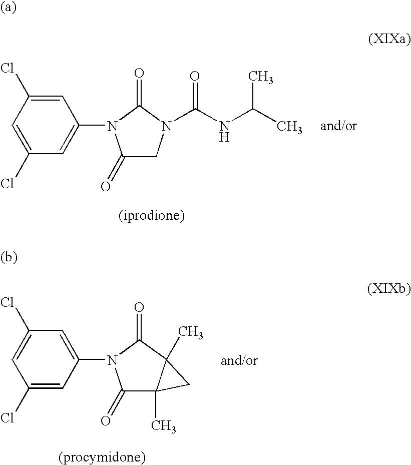
(19) a methoxyacrylate derivative of the formula 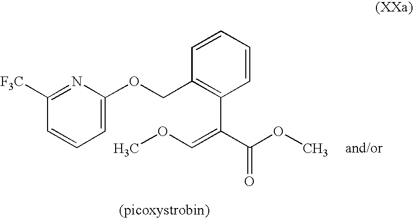
(20) a quinoline derivative of the formula 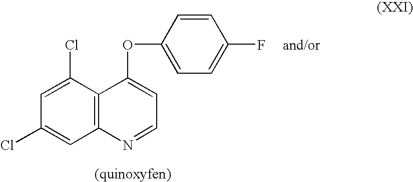
(21) a phenylamide derivative of the formula 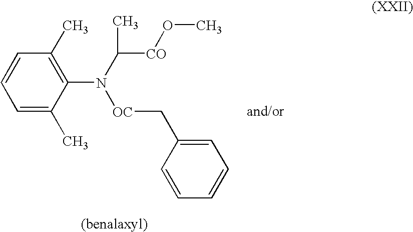
(22) phosphorous acid of the formula 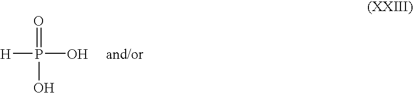
(23) a pyrrole derivative of the formula 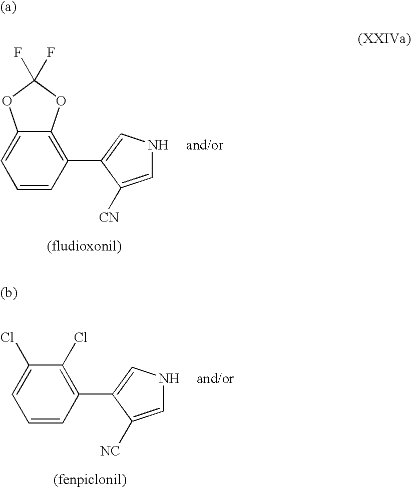
(24) a phenylcarbamate of the formula 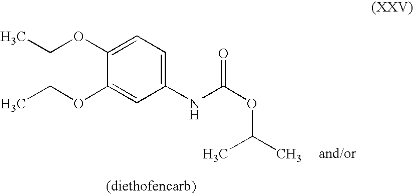
(25) copper hydroxide (XXVI)
and/or
(26) an imidazole derivative of the formula

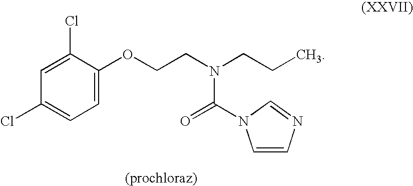

17: An active compound combination according to claim 16 comprising the compound of formula (I-a) and
(3) zineb (IV) and/or
(4) fenhexamid (V) and/or
(6) spiroxamine (VII) and/or
(7) the compound of formula (VIII) and/or
(8a) pyrimethanil (IXa) and/or
(8b) cyprodinil (IXb) and/or
(8c) mepanipyrim (IXc) and/or
(9) trifloxystrobin (X) and/or
(10) the compound of formula (XI) and/or
(11d) the compound of formula (XIId) and/or
(12) famoxadone (XIII) and/or
(13) zoxamide (XIV) and/or
(14) the compounds of formula (XV) and/or
(i 5) ethaboxam (XVI) and/or
(21) benalaxyl (XXII) and/or
(22) phosphorous acid (XXIII).

18: An active compound combination according to claim 16 comprising the compound of formula (I-a) and
(7) the compound of formula (VIII) and/or
(8a) pyrimethanil (IXa) and/or
(8b) cyprodinil (IXb) and/or
(8c) mepanipyrim (IXc) and/or
(9) trifloxystrobin (X) and/or
(11d) the compound of formula (XIId) and/or
(12) famoxadone (XIII) and/or
(13) zoxamide (XIV) and/or
(15) ethaboxam (XVI) and/or
(21) benalaxyl (XXII) and/or
(22) phosphorous acid (XXIII).

19: An active compound combination according to claim 16 wherein the weight ratio of the compound of the formula (I) to
(i) the compound of group (1a) is from 1:0.05 to 1:20,
(ii) the compound of group (1b) is from 1:0.05 to 1:20,
(iii) the compound of group (1c) is from 1:0.05 to 1:20,
(iv) the compound of group (1d) is from 1:0.05 to 1:20,
(v) the compound of group (1e) is from 1:0.05 to 1:20,
(vi) the compound of group (1f) is from 1:0.05 to 1:20,
(vii) the compound of group (1g) is from 1:0.05 to 1:20,
(viii) the compound of group (1h) is from 1:0.05 to 1:20,
(ix) the compound of group (1i) is from 1:0.05 to 1:20,
(x) the compound of group (2) is from 1:0.05 to 1:20,
(xi) the compound of group (3) is from 1:0.5 to 1:150,
(xii) the compound of group (4) is from 1:0.05 to 1:20,
(xiii) the compound of group (5) is from 1:0.05 to 1:20,
(xiv) the compound of group (6) is from 1:0.05 to 1:20,
(xv) the compound of group (7) is from 1:0.05 to 1:20,
(xvi) the compound of group (8) is from 1:0.05 to 1:20,
(xvii) the compound of group (9) is from 1:0.05 to 1:20,
(xviii) the compound of group (10) is from 1:0.05 to 1:20,
(xix) the compound of group (11a) is from 1:0.05 to 1:20,
(xx) the compound of group (11b) is from 1:0.05 to 1:20,
(xxi) the compound of group (11c) is from 1:0.05 to 1:20,
(xxii) the compound of group (11d) is from 1:0.05 to 1:20,
(xxiii) the compound of group (11e) is from 1:0.05 to 1:20,
(xxiv) the compound of group (11f) is from 1:0.05 to 1:20,
(xxv) the compound of group (11g) is from 1:0.05 to 1:20,
(xxvi) the compound of group (12) is from 1:0.05 to 1:20,
(xxvii) the compound of group (13) is from 1:0.05 to 1:20,
(xxviii) the compound of group (14) is from 1:0.5 to 1:150,
(xxix) the compound of group (15) is from 1:0.05 to 1:20,
(xxx) the compound of group (16) is from 1:0.05 to 1:20,
(xxxi) the compound of group (17) is from 1:0.05 to 1:20,
(xxxii) the compound of group (18a) is from 1:0.05 to 1:20,
(xxxiii) the compound of group (18b) is from 1:0.05 to 1:20,
(xxxiv) the compound of group (19) is from 1:0.05 to 1:20,
(xxxv) the compound of group (20) is from 1:0.05 to 1:20,
(xxxvi) the compound of group (21) is from 1:0.05 to 1:20,
(xxxvii) the compound of group (22) is from 1:0.5 to 1:150,
(xxxviii) the compound of group (23a) is from 1:0.05 to 1:20,
(xxxix) the compound of group (23b) is from 1:0.05 to 1:20,
(xl) the compound of group (24) is from 1:0.05 to 1:20,
(xli) the compound of group (25) is from 1:0.5 to 1:150,
(xlii) the compound of group (26) is from 1:0.05 to 1:20.

20: A method for controlling fungi comprising applying an effective amount of an active compound combination according to claim 12 to the fungi and/or their habitat.

21: A method for controlling fungi comprising applying an effective amount of an active compound combination according to claim 16 to the fungi and/or their habitat.

22: A process for preparing a fungicidal composition comprising mixing an active compound combination according to claim 12 with one or more extenders and/or surfactants.

23: A process for preparing a fungicidal composition comprising mixing an active compound combination according to claim 16 with one or more extenders and/or surfactants.
